(19) United States
(12) Patent Application Publication
(10) Pub. No.: US 2025/0112817 A1
(43) Pub. Date: Apr. 3, 2025

(54) COMMUNICATION SYSTEM

(71) Applicant: DENSO CORPORATION, Kariya-city (JP)

(72) Inventors: Taku INAGAWA, Kariya-city (JP); Tomohisa KISHIGAMI, Kariya-city (JP); Manahiro MORITA, Kariya-city (JP)

(21) Appl. No.: 18/894,579

(22) Filed: Sep. 24, 2024

(30) Foreign Application Priority Data
Sep. 28, 2023 (JP) 2023-167743

(51) Int. Cl. H04L 41/0631; H04L 41/0604; H04L 43/50

(52) U.S. Cl. CPC H04L 41/0645; H04L 41/0604; H04L 43/50

(57) ABSTRACT

A communication system comprises a plurality of communication nodes that relay failure diagnosis communication of a diagnosis request and a diagnosis result between a request source of a failure diagnosis and a request destination of the failure diagnosis. At least one of the communication nodes is configured to determine whether current communication is the failure diagnosis communication, and to pack a first communication frame of a first communication protocol whose use is defined in a communication standard of the failure diagnosis into a second communication frame of a second communication protocol having a higher communication speed than the first communication protocol.

### CROSS REFERENCE TO RELATED APPLICATION

This application is based on Japanese Patent Application No. 2023-167743 filed on Sep. 28, 2023, the disclosure of which is incorporated herein by reference.

### TECHNICAL FIELD

The present disclosure relates to a technique for performing failure diagnosis communication.

### BACKGROUND

A related art proposes a technique for performing failure diagnosis communication between a request source of a failure diagnosis and a request destination of a failure diagnosis such as a diagnosis tool connected to DLC or a center that performs wireless communication with DCM via a communication node such as a central gateway. DLC is an abbreviation for a Diagnostics Link Connector, and DCM stands for a Data Communication Module.

### SUMMARY

A communication system comprises a plurality of communication nodes that relay failure diagnosis communication of a diagnosis request and a diagnosis result between a request source of a failure diagnosis and a request destination of the failure diagnosis. At least one of the communication nodes is configured to determine whether current communication is the failure diagnosis communication, and to pack a first communication frame of a first communication protocol whose use is defined in a communication standard of the failure diagnosis into a second communication frame of a second communication protocol having a higher communication speed than the first communication protocol.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a communication system according to a first embodiment;

FIG. 2 is a block diagram illustrating a configuration of an ECU;

FIG. 3 is a block diagram illustrating a VM generated in a processor core;

FIG. 4 is a block diagram illustrating functions of an ECU;

FIG. 5 is a schematic diagram illustrating packing and unpacking of a communication frame;

FIG. 6 is a flowchart illustrating a failure diagnosis communication process;

FIG. 7 is a flowchart illustrating a failure diagnosis communication process; and

FIG. 8 is a block diagram illustrating a configuration of a communication system according to a second embodiment.

### DETAILED DESCRIPTION

A technique for performing failure diagnosis communication via a communication node such as a central gateway is known.

However, as a result of detailed studies by the inventors, it has been found that when the number of communication nodes that relay communication in the communication path between the request source of the failure diagnosis and the request destination of the failure diagnosis increases, the communication time required for the failure diagnosis communication increases.

In order to reduce the communication time required for the failure diagnosis communication, it is conceivable that the failure diagnosis communication is performed by a dedicated bus instead of a common bus with other communication. However, when a dedicated bus is installed for failure diagnosis communication, there is a problem that communication channels and buses are increased.

The present disclosure provides a technique for reducing a communication time required for failure diagnosis communication without using a dedicated bus for the failure diagnosis communication.

According to one aspect of the present disclosure, a communication system comprises: a plurality of communication nodes that relay failure diagnosis communication of a diagnosis request and a diagnosis result between a request source of a failure diagnosis and a request destination of the failure diagnosis. Any of the communication nodes includes a communication determination section configured to determine whether current communication is the failure diagnosis communication, and a communication setting section configured to, when the communication determination section determines that the current communication is the failure diagnosis communication at either a time of transmitting a diagnosis request from the request source to the request destination or a time of transmitting a diagnosis result from the request destination to the request source, pack a first communication frame of a first communication protocol whose use is defined in a communication standard of the failure diagnosis into a second communication frame of a second communication protocol having a higher communication speed than the first communication protocol.

According to this configuration, since the first communication frame is packed into the second communication frame, the time for generating the second communication frame can be shortened as compared with normal protocol conversion in which data of the first communication frame is analyzed to generate the second communication frame. The communication speed of the second communication protocol using the second communication frame is higher than the communication speed of the first communication protocol using the first communication frame.

As described above, since the first communication frame is packed into the second communication frame of the second communication protocol having a higher communication speed than the first communication protocol, the communication time required for the failure diagnosis communication can be reduced without installing a dedicated communication bus for failure diagnosis.

Hereinafter, embodiments of the present disclosure will be described with reference to the drawings.

### 1. First Embodiment

### (1-1. Configuration)

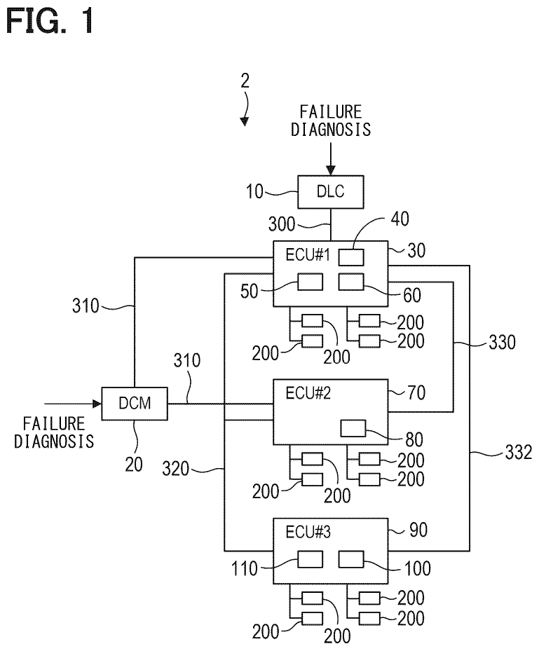

A communication system 2 illustrated in FIG. 1 is mounted on a vehicle, and includes a DLC 10, a DCM 20, and ECUs 30, 70, and 90. The ECU stands for an electronic control device. A vehicle includes, as a drive source, either an internal combustion engine or an electric motor to which electric power is supplied from a rechargeable battery. The internal combustion engine may be used for power generation to supply power to the rechargeable battery.

An external tool (not illustrated) is connected to the DLC 10. In the present embodiment, it is assumed that use of the CAN protocol is defined as a communication standard for failure diagnosis. Therefore, the DLC 10 and the ECU 30 communicate with each other in accordance with the CAN protocol via the bus 300. The CAN stands for a Controller Area Network, and is a registered trademark.

The DCM 20 communicates with a server (not illustrated) or the like via a network. The DCM stands for a Data Communication Module. The DCM 20 and the ECUs 30 and 70 communicate via a bus 310 in an Ethernet protocol. Ethernet is a registered trademark.

The ECUs 30, 70, and 90 are connected by a bus 320 corresponding to a partial network. The bus 320 is used in normal vehicle control.

The ECU 30 and the ECU 70 are connected by a bus 330, and the ECU 30 and the ECU 90 are connected by a bus 332. In the buses 330 and 332, communication is performed in accordance with the CAN FD protocol. The CAN FD stands for a CAN with Flexible Data Rate. The buses 330 and 332 are not used in normal vehicle control, and are used, for example, for data check and failure diagnosis when the ECUs 30, 70, and 90 communicate with each other.

In the present embodiment, a diagnosis request from an external tool or a server which is a request source of failure diagnosis is transmitted to a request destination of failure diagnosis such as the ECUs 30, 70, and 90 or a device 200 connected to the ECUs 30, 70, and 90.

In the present embodiment, since the DLC 10 is connected to the ECU 30, transmission of a diagnosis request from an external tool via the DLC 10 and transmission of a diagnosis result to an external tool via the DLC 10 are performed via the ECU 30.

In addition, transmission of a diagnosis request from the server via the DCM 20 and transmission of a diagnosis result to the server via the DCM 20 are performed via the ECU 30.

For example, when the ECU 70 receives a diagnosis request from the server to the ECU 90 via the DCM 20, the ECU 70 transmits the diagnosis request to the ECU 30 instead of transmitting the diagnosis request to the ECU 90. Then, a diagnosis request is transmitted from the ECU 30 to the ECU 90.

In a case where the diagnosis result is transmitted from the ECU 90 to the server, the ECU 90 transmits the diagnosis result to the ECU 30 instead of transmitting the diagnosis result to the ECU 70. Then, the diagnosis result is transmitted from the ECU 30 to the ECU 70.

Transmission of a diagnosis request from the server to the ECU 70 via the DCM 20 and transmission of a diagnosis result from the ECU 70 to the server via the DCM 20 are also performed from the ECU 70 via the ECU 30.

In the present embodiment, the reason why the transmission of the diagnosis request and the diagnosis result via the DLC 10 and the DCM 20 is performed via the ECU 30 is that only the ECU 30 has a function of checking whether the diagnosis request or the diagnosis result is appropriate.

Each of the ECUs 30, 70, and 90 includes one or more microcomputers including a processor core, a RAM, a ROM, and the like. Each of the ECUs 30, 70, and 90 is a gateway ECU such as a domain ECU that manages each group classified for each function or a zone ECU that manages each group classified for each position of the vehicle.

Various devices 200 such as a control ECU and an actuator are connected to each of the ECUs 30, 70, and 90. Each of the ECUs 30, 70, and 90 communicates with the device 200 in accordance with the CAN protocol, for example.

The ECU 30 includes three processor cores 40, 50, and 60, the ECU 70 includes one processor core 80, and the ECU 90 includes two processor cores 100 and 110. The number of processor cores included in the ECUs 30, 70, and 90 is an example and is not limited to the described number.

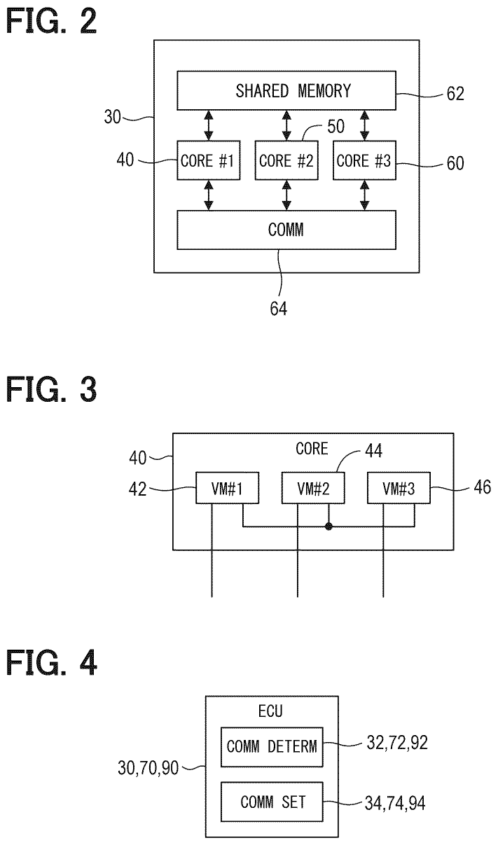

As illustrated in FIG. 2, the ECU 30 includes a shared memory 62 and a communication section 64 in addition to the plurality of processor cores 40, 50, and 60. The communication section 64 includes a communication controller and a communication switch corresponding to a communication protocol with which the ECU 30 communicates with the DLC 10, the ECUs 70 and 90, and the device 200 of the subject ECU.

The ECUs 70 and 90 also have the same configuration as the ECU 30 illustrated in FIG. 2 although the number of processor cores is different.

In addition, as illustrated in FIG. 3, the processor core 40 generates a plurality of VMs 42, 44, and 46. The VM stands for a virtual machine. The processor cores of the other processor cores 50 and 60 and the other ECUs 70 and 90 may also generate a plurality of VMs.

Communication among the processor cores 40, 50, and 60 is performed via the shared memory 62 or the communication section 64. In addition, communication among the VMs 42, 44, and 46 is performed via a virtual CAN bus, a virtual CAN FD bus, a virtual Ethernet bus, and the like.

As illustrated in FIG. 4, the ECUs 30, 70, and 90 function as communication determination sections 32, 72, and 92 and communication setting sections 34, 74, and 94, respectively. The functions of the communication determination sections 32, 72, and 92 and the communication setting sections 34, 74, and 94 will be described in the following (1-2. Failure diagnosis process).

### (1-2. Failure Diagnosis Process)

The following failure diagnosis process is executed by the ECUs 30, 70, and 90. Note that which processor core of each ECU executes the failure diagnosis process, and in a case where any of the processor cores generates the VM, which VM executes the failure diagnosis process is set in advance or appropriately determined according to a processing condition.

### (1) Packing Process

(1-1) at the Time of Diagnosis Request from DLC 10

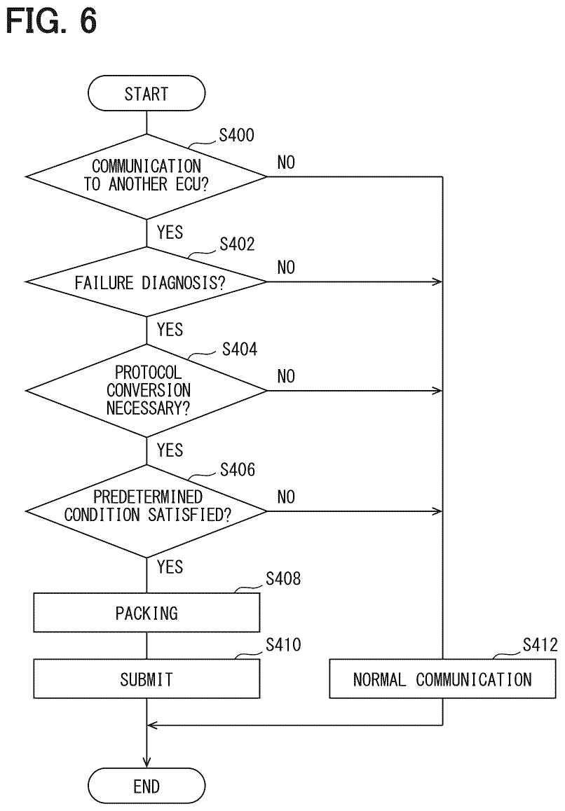

In a case where the ECU 30 receives the communication from the DLC 10 via the bus 300, a communication determination section 32 determines in S400 of FIG. 6 whether the current communication is addressed to another ECU other than the subject ECU.

In the case of communication from the DLC 10 via the bus 300, the communication determination section 32 determines whether the current communication is communication addressed to another ECU other than the subject ECU based on the ID of the received CAN frame.

In a case where the determination in S400 is No, that is, in a case where the current communication is not addressed to another ECU other than the subject ECU, the process proceeds to S412.

In a case where the determination in S400 is Yes, in S402, the communication determination section 32 determines whether the current communication is the failure diagnosis communication based on the value of the data at the predetermined position in the data field of the received CAN frame, for example. In this case, the communication determination section 32 functions as a first communication determination section.

In a case where the determination in S402 is No, that is, in a case where the current communication is not the failure diagnosis communication, the process proceeds to S412.

In a case where the determination in S402 is Yes, that is, in a case where the current communication is the failure diagnosis communication, the communication determination section 32 determines in S404 whether the communication protocol is required to be converted in the current communication. In a case where the determination in S404 is No, that is, in a case where the communication protocol does not need to be converted in the current communication, the process proceeds to S412.

In a case where the ECU 30 receives the diagnosis request from the DLC 10 and the destination is another ECU 70 or 90 other than the ECU 30, the communication protocol is converted in order to transmit the CAN frame received from the DLC 10 to the buses 330 and 332. Therefore, the determination in S404 is Yes.

In a case where the determination in S404 is Yes, that is, in a case where the communication protocol is required to be converted in the current communication, the communication determination section 32 determines in S406 whether a predetermined condition for executing the packing process is satisfied. Hereinafter, predetermined conditions (a) to (e) are shown.

(a) An external tool for failure diagnosis is connected to the DLC 10.

(b) Either the manual parking gear or the side brake or the electric parking

brake stops the vehicle.

(c) In a case where the vehicle includes an electric motor as a drive source, a rechargeable battery that supplies electric power to the electric motor is being charged.

(d) The vehicle comprises an internal combustion engine and is being fueled.

(e) In the bus used this time, an amount of communication other than the failure diagnosis communication is equal to or less than a predetermined amount, and the failure diagnosis communication does not interfere with other communication.

In a case where the determination in S406 is No, that is, in a case where none of the predetermined conditions (a) to (e) for executing the packing process is satisfied, the process proceeds to S412.

In a case where any one of the predetermined conditions (a) to (e) for executing the packing process is satisfied, the determination in S404 is Yes.

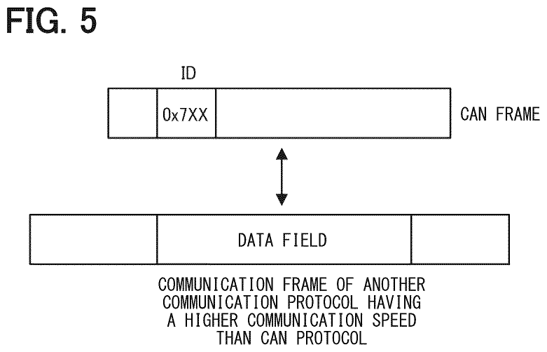

In this case, in S408, as illustrated in FIG. 5, the communication setting section 34 packs the received CAN frame into the data field of the CAN FD frame of the CAN FD protocol having a higher communication speed than the CAN protocol. In this case, the communication setting section 34 functions as a first communication setting section.

In a case where the ECU 30 receives the diagnosis request from the DLC 10 in the CAN frame, the ID of the CAN frame is 0x7XX. The communication setting section 34 does not change the ID of the CAN frame received from the DLC 10 with 0x7XX as it is and packs the ID into the CAN FD frame. At this time, the communication setting section 34 changes the ID of the CAN FD to 0x0XX from 0x7XX set in the ID of the CAN frame to increase the priority of communication.

Then, in S410, the communication setting section 34 transmits the CAN FD frame obtained by packing the CAN frame to the bus 330 or the bus 332 to be used this time.

In step S412, the communication setting section 34 executes normal communication for transmitting a communication frame of a corresponding communication protocol with performing protocol conversion when the normal protocol conversion is necessary for the received communication frame or without performing protocol conversion when the normal protocol conversion is unnecessary, and terminates the process.

In the process of S412, the normal protocol conversion means that the content of the received communication frame is analyzed and redisposed to the configuration of the communication frame corresponding to the communication protocol to be transmitted.

(1-2) At the Time of Diagnosis Request from DCM 20

In a case where the ECU 70 receives data from the DCM 20 via the bus 310, the communication determination section 72 determines whether the current communication is addressed to another ECU other than the subject ECU based on the destination MAC address of the Ethernet frame in S400 of FIG. 6.

In a case where the determination in S400 is No, that is, in a case where the current communication is not addressed to another ECU other than the subject ECU, the communication determination section 72 shifts the process to S412.

In a case where the determination in S400 is Yes, in S402, the communication determination section 72 determines whether the current communication is the failure diagnosis communication based on the value of the data at the predetermined position in the data field of the received Ethernet frame, for example. In this case, the communication determination section 72 functions as a first communication determination section.

In a case where the determination in S402 is No, that is, in a case where the current communication is not the failure diagnosis communication, the process proceeds to S412.

In a case where the determination in S402 is Yes, that is, in a case where the current communication is the failure diagnosis communication, the communication determination section 72 determines in S404 whether the communication protocol is required to be converted in the current communication. In a case where the determination in S404 is No, that is, in a case where the communication protocol does not need to be converted in the current communication, the process proceeds to S412.

For example, in a case where a diagnosis request from the DCM 20 is transmitted from the ECU 70 to the ECU 90 via the ECU 30, or in a case where a diagnosis request is transmitted from the ECU 70 to the ECU 70 via the ECU 30, in the ECU 30 the communication protocol is not converted with the CAN FD as it is. In this case, the determination in S404 is No.

In a case where the determination in S404 is Yes, that is, in a case where the communication protocol is required to be converted in the current communication, the communication determination section 72 determines in S406 whether the above-described predetermined condition for executing the packing process is satisfied. In (e) of the predetermined condition described above, the communication determination section 72 determines whether the amount of communication other than the failure diagnosis communication is equal to or less than the predetermined amount in the bus 330 in which the ECU 30 and the ECU 70 are connected.

In a case where the determination in S406 is No, that is, in a case where the predetermined condition for executing the packing process is not satisfied, the process proceeds to S412.

In a case where the determination in S406 is Yes, that is, in a case where the predetermined condition for executing the packing process is satisfied, in S408, the communication setting section 74 packs the CAN frame used in the diagnosis request into the data field of the CAN FD frame as illustrated in FIG. 5. In this case, the communication setting section 74 functions as a first communication setting section.

Since the ECU 70 has not received the CAN frame used in the diagnosis request from the DCM 20, the communication setting section 74 generates a CAN frame in which 0x7XX is set in the ID and packs the CAN frame into the data field of the CAN FD frame. At this time, the communication setting section 74 changes the ID of the CAN FD to 0x0XX from 0x7XX set in the ID of the CAN frame to increase the priority of communication.

In S410, the communication setting section 74 transmits the CAN FD frame in which the CAN frame is packed to the bus 330 used this time.

In S412, the communication setting section 74 executes the normal communication described above, and terminates the process.

(1-3) At the Time of Transmitting Diagnosis Result from Subject ECU or Device 200 of Subject ECU

In a case where the diagnosis result received from the device 200 connected to the ECU 30 or the diagnosis result by the subject ECU is transmitted, the communication determination section 32 determines in S400 of FIG. 6 whether the current communication is addressed to another ECU other than the subject ECU.

In a case of transmitting the diagnosis result by the subject ECU, the communication determination section 32 determines whether the communication is addressed to another ECU other than the subject ECU.

On the other hand, in the case of communication from device 200 connected to the subject ECU, the communication determination section 32 determines whether the current communication is addressed to another ECU other than the subject ECU based on the ID of the CAN frame received from device 200.

In the case of the ECU 30, in a case where the subject ECU or the device 200 connected to the subject ECU transmits a diagnosis result in response to a diagnosis request from the DLC 10, the DLC 10 is a destination, and thus other ECUs are not destinations. In this case, the determination in S400 is No.

On the other hand, in response to the diagnosis request from the DCM 20, in the ECU 30, the destination to which the subject ECU or the device 200 connected to the subject ECU transmits the diagnosis result is the ECU 70 which is another ECU. In this case, the determination in S400 is Yes.

In the case of the ECUs 70 and 90, in a case where the subject ECU or the device 200 connected to the subject ECU transmits a diagnosis result in response to a diagnosis request from the DLC 10 or a diagnosis request from the DCM 20, the diagnosis result temporarily passes through the ECU 30 in the present embodiment. Therefore, since the ECU 30 as another ECU is the destination, the determination in S400 is Yes.

In a case where the determination in S400 is No, that is, in a case where the current communication destination is not another ECU other than the subject ECU, the process proceeds to S412.

In a case where the determination in S400 is Yes, that is, in a case where the current communication destination is another ECU other than the subject ECU, the communication determination sections 32, 72, and 92 determine whether the current communication is failure diagnosis communication in S402. In this case, the communication determination sections 32, 72, and 92 function as second communication determination sections. In a case where the determination in S402 is No, that is, in a case where the communication of the current communication is not the failure diagnosis communication, the process proceeds to S412.

In a case where the determination in S402 is Yes, that is, in a case where the current communication is the failure diagnosis communication, the communication determination sections 32, 72, and 92 determine in S404 whether the communication protocol is required to be converted in the current communication. In a case where the determination in S404 is No, that is, in a case where the communication protocol does not need to be converted in the current communication, the process proceeds to S412.

In a case where the diagnosis result is transmitted from the subject ECU or the device 200 of the subject ECU to another ECU, the communication protocol is converted in order to transmit the CAN frame in which the diagnosis result is set to the buses 330 and 332 in which the CAN FD protocol is used. In this case, the determination in S404 is Yes.

In a case where the determination in S404 is Yes, that is, in a case where the communication protocol is required to be converted in the current communication, the communication determination sections 32, 72, and 92 determine in S406 whether the above-described predetermined condition for executing the packing process is satisfied. In a case where the determination in S406 is No, that is, in a case where the predetermined condition for executing the packing process is not satisfied, the process proceeds to S412.

In a case where the determination in S406 is Yes, that is, in a case where the predetermined condition for executing the packing process is satisfied, the communication setting sections 34, 74, and 94 execute the packing process in S408. In this case, the communication setting sections 34, 74, and 94 function as second communication setting sections.

In a case of transmitting the diagnosis result of the subject ECU, the communication setting sections 34, 74, and 94 generate CAN frames and pack the generated CAN frames into CAN FD frames.

In a case where the device 200 connected to the subject ECU transmits a diagnosis result, the communication setting sections 34, 74, and 94 pack CAN frames received from the device 200 into CAN FD frames. In this case, the communication setting sections 34, 74, and 94 function as second communication setting sections.

In any case of packing the CAN frame into the CAN FD frame, the ID of the CAN frame is 0x7XX, and the ID of the CAN FD is set to 0x0XX to increase the priority of communication.

Since the following processing in S410 and S412 is substantially the same as the processing in S410 and S412 (1-1) at the time of transmitting the diagnosis request from the DLC 10 described above, the description thereof will be omitted.

### (2) Unpacking Process

Since the following processing is executed by any of the ECUs 30, 70, and 90 and is basically the same processing, the ECU 30 will be described as an example.

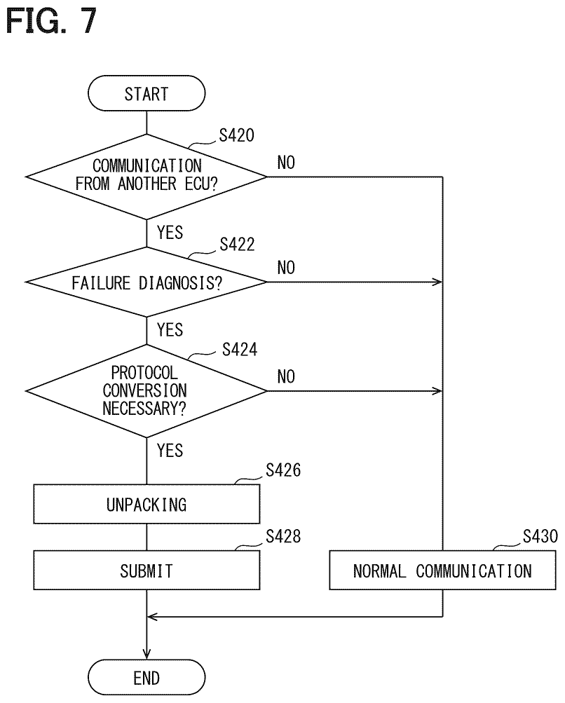

In S420 of FIG. 7, the communication determination section 32 determines whether the current communication is communication from another ECU.

In a case where the determination in S420 is No, that is, in a case where the current communication is not communication from another ECU, the process proceeds to S430.

In a case where the determination in S420 is Yes, that is, in a case where the current communication is communication from another ECU, the communication determination section 32 determines in S422 whether the current communication is failure diagnosis communication. In this case, the communication determination section 32 functions as a second communication determination section.

The determination in S422 is Yes in any of the following cases (a) to (c), for example.

(a) The ECUs 70 and 90 receive a CAN FD frame representing a diagnosis request for the subject ECU or the device 200 connected to the subject ECU from the DLC 10 or the DCM 20 via the ECU 30.

(b) The ECU 30 receives, from the ECU 70, a CAN FD frame representing a diagnosis request from the DCM 20 for the subject ECU or the device 200 connected to the subject ECU.

(c) The ECU 30 receives from the ECUs 70 and 90, a CAN FD frame representing a diagnosis result for the diagnosis request from the DLC 10.

In a case where the determination in S422 is No, that is, in a case where the CAN FD frame received from another ECU is not based on the failure diagnosis communication, the communication determination section 32 shifts the process to S430.

In a case where the determination in S422 is Yes, that is, in a case where the CAN FD frame received from another ECU is based on the failure diagnosis communication, the communication determination section 32 determines in S424 whether the communication protocol is required to be converted in the current communication. In a case where the determination in S424 is No, that is, in a case where the communication protocol does not need to be converted in the current communication, the process proceeds to S430.

For example, in the case of transmission of the diagnosis result from the ECU 70 or the ECU 90 to the ECU 30 via the ECU 70, the communication protocol is not converted in the ECU 30 with the CAN FD as it is, and thus the determination in S424 is No.

In a case where the determination in S424 is Yes, that is, in a case where the communication protocol is required to be converted in the current communication, the communication setting section 34 unpacks the CAN frame from the received CAN FD frame in S426 as illustrated in FIG. 5. In this case, the communication setting section 34 functions as a second communication setting section. 0x7XX of the ID of the CAN frame packed into the CAN FD frame is set in the ID of the unpacked CAN frame.

In S428, the communication setting section 34 executes any one of events in which the failure diagnosis in the subject ECU based on the unpacked CAN frame, the CAN frame is transmitted to the device 200 connected to the subject ECU, and the CAN frame is transmitted to the DLC 10, and terminates the present processing.

In S430, the communication setting section 34 executes the normal communication described above, and terminates the process.

In the first embodiment described above, the CAN protocol corresponds to the first communication protocol, the CAN frame corresponds to the first communication frame, the CAN FD protocol corresponds to the second communication protocol, and the CAN FD frame corresponds to the second communication frame.

In addition, a 0x7 portion representing the priority in the ID of the CAN frame and a 0x0 portion of the ID representing the priority in the CAN FD frame correspond to the priority parameter.

Further, the ECUs 30, 70, and 90, the processor cores 40, 50, 60, 80, 100, and 1106, the VMs 42, 44, and 46 correspond to a communication node, a first communication node, and a second communication node.

Further, S402, S406, and S422 correspond to the processing of the communication determination section, and S408, S410, S426, and S428 correspond to the processing of the communication setting section.

### (1-3. Effects)

According to the first embodiment described above, the following effects can be obtained.

(1a) A CAN frame of a CAN protocol whose use is defined in a communication standard of failure diagnosis is packed into a CAN FD frame of a CAN FD protocol having a higher communication speed than the CAN protocol and transmitted. This makes it possible to reduce the communication time required for failure diagnosis without using a dedicated communication bus for failure diagnosis.

(1b) Since the CAN frame is packed into the CAN FD frame instead of normal protocol conversion, the time for generating the CAN FD frame from the CAN frame can be shortened.

(1c) When the CAN frame is packed into the CAN FD frame, the priority of communication by the CAN FD frame is higher than the priority of communication by the CAN frame, so that it is possible to suppress a delay in failure diagnosis communication. As a result, the communication time required for failure diagnosis can be further reduced.

### 2. Second Embodiment

(2.-1. Difference from First Embodiment)

Since the basic configuration of the second embodiment is similar to that of the first embodiment, differences will be described below. Note that the same reference numerals as those in the first embodiment indicate the same configuration, and reference is made to the preceding description.

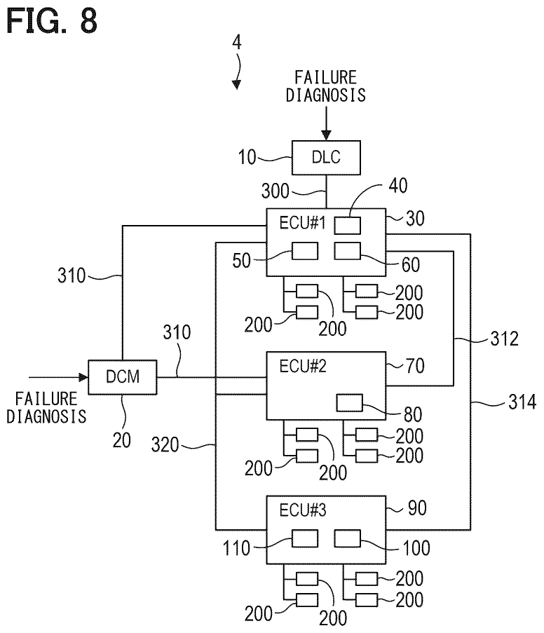

In the first embodiment described above, the ECUs 30, 70, and 90 include the buses 330 and 332 that communicate in accordance with the CAN FD protocol. On the other hand, the second embodiment illustrated in FIG. 8 is different from the first embodiment in that the ECUs 30, 70, and 90 are connected by buses 312 and 314 communicating in accordance with the Ethernet protocol instead of the buses 330 and 332.

Note that the buses 312 and 314 may be used in part of normal vehicle control in addition to data check when the ECUs 30, 70, and 90 communicate with each other.

### (2-2. Failure Diagnosis Process)

### (1) Packing Process

(1-1) At the Time of Transmitting Diagnosis Request from DLC 10

In the following processing, since substantially the same processing as S400 to S406 and S412 of FIG. 6 described in “(1-1) At the time of transmitting diagnosis request from DLC 10 of the first embodiment” is executed, description of the corresponding processing is omitted.

In S408 of FIG. 6, as illustrated in FIG. 5, the communication setting section 34 packs the received CAN frame into the data field of the Ethernet frame of the Ethernet protocol having a higher communication speed than the CAN protocol. In this case, the communication setting section 34 functions as a first communication setting section.

Then, in S410, the communication setting section 34 transmits the Ethernet frame in which the CAN frame is packed to the buses 312 and 314 connected to the destination ECU.

At this time, the communication setting section 34 sets the priority corresponding to the priority represented by 0x0XX set to increase the priority of the CAN FD in the first embodiment to the PCP in the tag field of the Ethernet frame to increase the priority of communication.

(1-2) At the Time of Transmitting Diagnosis Request from DCM 20

In the following processing, since substantially the same processing as S400 to S406 and S412 of FIG. 6 described in “(1-2) At the time of transmitting diagnosis request from DCM 20” of the first embodiment is executed, the description of the corresponding processing is omitted.

In S408 of FIG. 6, as illustrated in FIG. 5, the communication setting section 74 packs the CAN frame used in the diagnosis request into the data field of the Ethernet frame. In this case, the communication setting section 74 functions as a first communication setting section. At this time, the communication setting section 74 sets the priority corresponding to the priority represented by 0x0XX set to increase the priority of the CAN FD in the first embodiment to the PCP in the tag field of the Ethernet frame to increase the priority of communication.

Then, in step S410, the communication setting section 74 transmits to the bus 312, the Ethernet met frame in which the CAN frames are packed in either a case where the request destination of the failure diagnosis is the ECU 30 or a case where the request destination of the failure diagnosis is the ECUs 70 and 90.

This is because only the ECU 30 has the function of checking whether the diagnosis request or the diagnosis result is proper as described above, and thus the ECU 30 checks whether the failure diagnosis is appropriate.

(1-3) At the Time of Transmitting Diagnosis Result from Subject ECU or Device 200 Connected to Subject ECU

In the following processing, since substantially the same processing as S400 to S406 and S412 in FIG. 6 described in “(1-3) At the time of transmitting diagnosis result from subject ECU or device 200 connected to subject ECU” of the first embodiment is executed, description of the corresponding processing is omitted.

In S408, the communication setting sections 34, 74, and 94 execute a packing process. In this case, the communication setting sections 34, 74, and 94 function as second communication setting sections.

In a case where the diagnosis result of the subject ECU is transmitted, in S408, the communication setting sections 34, 74, and 94 generate CAN frames, and pack the generated CAN frames into Ethernet frames.

In a case where the device 200 connected to the subject ECU transmits the diagnosis result, in S408, the communication setting sections 34, 74, and 94 pack the CAN frame received from the device 200 into the Ethernet frame.

The ID of the CAN frame used in the failure diagnosis is 0x7XX as described above. The communication setting section 34 packs the Ethernet frame without changing the ID of the CAN frame with 0x7XX as it is.

At this time, the communication setting sections 34, 74, and 94 set the priority corresponding to the priority represented by 0x0XX set to increase the priority of the CAN FD in the first embodiment to the PCP in the tag field of the Ethernet frame to increase the priority of communication.

Then, in S410, the communication setting sections 34, 74, and 94 transmit the Ethernet frame in which the CAN frame is packed to the bus 312 or the bus 314 to which the destination ECU is connected.

### (2) Unpacking Process

In “(2) Unpacking process” described in the first embodiment, since the processing is substantially the same as the processing in which the CAN FD is replaced with the Ethernet, the description thereof will be omitted.

In the second embodiment described above, the CAN corresponds to the first communication protocol, the CAN frame corresponds to the first communication frame, the Ethernet protocol corresponds to the second communication protocol, and the Ethernet frame corresponds to the second communication frame.

In addition, the PCP in the tag field of the Ethernet frame corresponds to the priority parameter.

### (2-3. Effects)

According to the second embodiment described above, in the effects (1a) to (1c) of the first embodiment described above, it is possible to obtain substantially the same effects as the description in which the CAN FD is replaced with the Ethernet.

### 3. Other Embodiments

Although the embodiments of the present disclosure have been described above, the present disclosure is not limited to the above-described embodiments, and various modifications can be made.

(3a) In the embodiment described above, the CAN FD protocol or the Ethernet protocol is used as a communication protocol with a higher communication speed than the CAN protocol, but the present disclosure is not limited thereto. For example, the CAN XL protocol may be used.

(3b) In the embodiment described above, in a case where the CAN frame is packed into a communication frame of a communication protocol having a higher communication speed than the CAN protocol, the priority of the priority parameter representing the priority of communication is increased. On the other hand, the priority of the priority parameter representing the priority of communication may remain the same.

(3c) In the embodiment described above, the processing of packing the first communication frame into the second communication frame is performed in both the failure diagnosis communication from the request source to the request destination of the failure diagnosis and the failure diagnosis communication from the request destination to the request source of the failure diagnosis, but the present disclosure is not limited thereto. Processing of packing the first communication frame into the second communication frame may be performed in only one or the other of the communication path from the request source to the request destination of the failure diagnosis or the communication path from the request destination to the request source of the failure diagnosis.

(3d) As long as the first communication frame can be packed into the second communication frame, any communication node may execute the packing process in the communication path from the request source to the request destination of the failure diagnosis and the communication path from the request destination to the request source of the failure diagnosis.

(3e) In the embodiment described above, only the ECU 30 connected to the DLC 10 has the function of checking whether the diagnosis request or the diagnosis result is appropriate, but the present disclosure is not limited thereto.

Since the ECU 70 connected to the DCM 20 also has a function of checking whether the diagnosis request or the diagnosis result is appropriate, transmission of the diagnosis request from the ECU 70 and transmission of the diagnosis result to the ECU 70 can be performed without passing through the ECU 30. In this case, in the embodiment described above, the ECU 70 is required to be connected to each of the ECUs 30 and 90 via a bus of the CAN FD protocol or the Ethernet protocol.

(3f) In the embodiment described above, the CAN protocol is exemplified as the first communication protocol whose use is defined in the communication standard for failure diagnosis, but the present disclosure is not limited thereto. When the communication standard of the failure diagnosis is changed, the first communication protocol may be, for example, CAN FD or Ethernet. In this case, a second communication protocol with a higher communication speed than the CAN FD protocol or the Ethernet protocol is used.

(3g) In the embodiment described above, the failure diagnosis communication is executed not by the bus 320 of the partial network used in the vehicle control but by the buses 330 and 332 or the buses 312 and 314 for performing the data check when the ECUs 30, 70, and 90 communicate with each other. On the other hand, the failure diagnosis communication may be executed by the bus 320 used in the vehicle control without installing the buses 330, 332, 312, and 314. In this case, the communication protocol used by the bus 320 has a communication speed higher than that of at least the CAN protocol.

(3h) In the embodiment described above, the communication systems 2 and 4 including the three ECUs 30, 70, and 90 have been described. In this case, the number of ECUs relaying the failure diagnosis communication is three at the maximum as illustrated in the second embodiment. On the other hand, the number of ECUs may be four or more. The failure diagnosis communication may be relayed by four or more ECUs.

(3i) The communication systems 2 and 4 and the method thereof described in the present disclosure may be realized by a dedicated computer provided by configuring a processor and a memory programmed to execute one or a plurality of functions embodied by a computer program.

Alternatively, the communication systems 2 and 4 and the method thereof described in the present disclosure may be realized by a dedicated computer provided by configuring a processor by one or more dedicated hardware logic circuits.

Alternatively, the communication systems 2 and 4 and the method thereof described in the present disclosure may be realized by one or more dedicated computers configured by a combination of a processor and a memory programmed to execute one or more functions and a processor configured by one or more hardware logic circuits.

Furthermore, the computer program may be stored in a computer-readable non-transition tangible recording medium as an instruction executed by a computer. The method for realizing the functions of the units included in the communication systems 2 and 4 do not necessarily include software, and all the functions may be realized using one or a plurality of pieces of hardware.

(3j) A plurality of functions of one component in the above embodiment may be implemented by a plurality of components, or one function of one component may be implemented by a plurality of components. A plurality of functions of a plurality of components may be implemented by one component, or one function realized by a plurality of components may be implemented by one component. Part of the configuration of the above embodiment may be omitted. At least part of the configuration of the above embodiment may be added to or replaced with the configuration of another above embodiment.

(3k) In addition to the communication systems 2 and 4 described above, the present disclosure can be implemented in various forms such as a program for causing a computer to function as the communication systems 2 and 4, a non-transitory tangible recording medium such as a semiconductor memory in which the program is recorded, and a communication method.

What is claimed is:

1. A communication system comprising:
a plurality of communication nodes that relay failure diagnosis communication of a diagnosis request and a diagnosis result between a request source of a failure diagnosis and a request destination of the failure diagnosis,
wherein
any of the communication nodes includes
a communication determination section configured to determine whether current communication is the failure diagnosis communication, and
a communication setting section configured to, when the communication determination section determines that the current communication is the failure diagnosis communication at either a time of transmitting a diagnosis request from the request source to the request destination or a time of transmitting a diagnosis result from the request destination to the request source, pack a first communication frame of a first communication protocol whose use is defined in a communication standard of the failure diagnosis into a second communication frame of a second communication protocol having a higher communication speed than the first communication protocol.

2. The communication system according to claim 1, wherein
a communication node of the communication nodes corresponds to a first communication node,
the communication determination section corresponds to a first communication determination section,
the communication setting section corresponds to a first communication setting section,
the first communication setting section packs the first communication frame into the second communication frame when the first communication determination section determines that the current communication is the failure diagnosis communication at either the time of transmitting the diagnosis request or the time of transmitting the diagnosis result, and
a second communication node other than the first communication node among the plurality of communication nodes includes
a second communication determination section configured to determine whether the current communication is the failure diagnosis communication, and
a second communication setting section configured to unpack the first communication frame from the second communication frame when the second communication determination section determines that the current communication is the failure diagnosis communication at either the time of transmitting the diagnosis request or the time of transmitting the diagnosis result.

3. The communication system according to claim 2, wherein
the second communication setting section packs the first communication frame into the second communication frame when the second communication determination section determines that the current communication is the failure diagnosis communication at another of the time of transmitting the diagnosis request and the time of transmitting the diagnosis result, and
the first communication setting section unpacks the first communication frame from the second communication frame when the first communication determination section determines that the current communication is the failure diagnosis communication at another of the time of transmitting the diagnosis request and the time of transmitting the diagnosis result.

4. The communication system according to claim 1, wherein
the communication setting section increases a priority of a priority parameter representing a priority of communication in the second communication frame when packing the first communication frame into the second communication frame.

5. The communication system according to claim 1, wherein
the communication setting section packs the first communication frame into the second communication frame when the communication determination section determines that the current communication is the failure diagnosis communication and further that at least one of a manual parking gear, a side brake, or an electric parking brake is in a state of stopping a vehicle.

6. The communication system according to claim 1, wherein
the communication setting section packs the first communication frame into the second communication frame when the communication determination section determines that the current communication is the failure diagnosis communication and further that an external tool for failure diagnosis is connected to the communication system as the request source of the failure diagnosis.

7. The communication system according to claim 1, wherein
the communication setting section packs the first communication frame into the second communication frame when the communication determination section determines that the current communication is the failure diagnosis communication and further that a vehicle includes an electric motor as a drive source, and that a rechargeable battery that supplies power to the electric motor is being charged.

8. The communication system according to claim 1, wherein
the communication setting section packs the first communication frame into the second communication frame when the communication determination section determines that the current communication is the failure diagnosis communication and further that a vehicle includes an internal combustion engine, and that the vehicle is being fueled.

9. The communication system according to claim 1, wherein
the communication setting section packs the first communication frame into the second communication frame when the communication determination section determines that the current communication is the failure diagnosis communication and further that an amount of communication other than the failure diagnosis communication is equal to or less than a predetermined amount.

10. The communication system according to claim 1, wherein
the first communication protocol is a CAN protocol.

11. The communication system according to claim 1, wherein
at least one of the communication nodes is an electronic control device.

12. The communication system according to claim 1, wherein
at least one of the communication nodes is a processor core.

13. The communication system according to claim 1, wherein
at least one of the communication nodes is a virtual machine.
